(19) United States
(12) Patent Application Publication
(10) Pub. No.: US 2026/0301681 A1
(43) Pub. Date: Oct. 1, 2026

(54) GATE DRIVING CIRCUIT AND DISPLAY DEVICE INCLUDING THE SAME

(71) Applicants: LG Display Co., Ltd., Seoul (KR); Seoul National University R&DB Foundation, Seoul (KR)

(72) Inventors: Moon Seok JUNG, Paju-si (KR); Key Young YANG, Paju-si (KR); Sang Hee YU, Paju-si (KR); Soo Yeon LEE, Seoul (KR)

(21) Appl. No.: 19/411,599

(22) Filed: Dec. 8, 2025

(30) Foreign Application Priority Data
Mar. 28, 2025 (KR) 10-2025-0039987

(51) Int. Cl. G09G 3/3266; G09G 3/3233

(52) U.S. Cl. CPC G09G 3/3266; G09G 3/3233; G09G 2300/0819; G09G 2300/0852; G09G 2310/0286; G09G 2310/0291; G09G 2310/08; G09G 2330/021; G09G 2340/0435

(57) ABSTRACT

A gate driving circuit and a display device including the same. A signal transmitter of a gate driving circuit includes a clock node to which a clock signal is input; a first input node to which a first input signal is input; a second input node to which a second input signal is input; a first carry signal node to which a first carry signal is input; a second carry signal node to which a second carry signal is input; and a first output node from which a first output signal is output.

### CROSS REFERENCE TO RELATED APPLICATION

This application claims priority from and the benefit of Korean Patent Application No. 10-2025-0039987, filed on Mar. 28, 2025, which is hereby incorporated by reference for all purposes as if fully set forth herein.

### BACKGROUND

### FIELD

Embodiments of the invention relate generally invention to an apparatus, and more particularly, to a gate driving circuit and a display device including the same.

### DISCUSSION OF THE BACKGROUND

Various flat panel displays such as a liquid crystal display and an electroluminescence display are known. The electroluminescence display may use light-emitting elements provided in each of pixels to emit light by itself without a backlight and may display an input image. The light-emitting elements of the electroluminescence display may be divided into organic light-emitting elements and inorganic light-emitting elements depending on a material for a light-emitting layer. An active matrix type electroluminescence display has advantages of a high response speed, high light emission efficiency, high luminance, and a wide viewing angle since an organic light emitting diode (hereinafter, referred to as an “OLED”) is provided in each pixel, and is excellent in contrast ratio and color reproducibility since a black grayscale can be expressed as complete black.

Conventional display devices typically include a display panel driving circuit that drives pixels to visually reproduce an input image on a screen of a display panel. The display panel driving circuit includes a data driving circuit that drives data lines, and a gate driving circuit that drives gate lines. When a compensation circuit is further provided in the pixels, gate signals that are generated at different waveforms increase. In this case, the gate driving circuit increases in size and power consumption.

The above information disclosed in this Background section is only for understanding of the background of the inventive concepts, and, therefore, it may contain information that does not constitute prior art.

### SUMMARY

Display devices according to embodiments of the invention are capable of outputting gate signals with different waveforms and improving circuit size and power consumption, and a display device including the same.

Additional features of the inventive concepts will be set forth in the description which follows, and in part will be apparent from the description, or may be learned by practice of the inventive concepts.

According to one or more embodiments of the invention, a gate driving circuit includes a plurality of signal transmitters to which a clock signal is applied. Each of the signal transmitters includes: a clock node to which the clock signal is input; a first input node to which a first input signal is input; a second input node to which a second input signal is input; a first carry signal node to which a first carry signal is input; a second carry signal node to which a second carry signal is input; and a first output node from which a first output signal is output.

The first input signal and the second input signal may be opposite in phase to each other. The first input signal may be a first start signal or a first carry signal that is output from a previous signal transmitter. The second input signal may be a second start signal having an inverted phase with respect to the first start signal or a second carry signal that is output from the previous signal transmitter.

A pulse width of the first output signal may be varied in proportion to a pulse width of the input signal.

Each of the signal transmitters may further include a second output node from which a second output signal having an inverted phase with respect to the first output signal is output.

Each of the signal transmitters may include: a first control node; a second control node; and an input circuit part and an output circuit part connected to the first control node and the second control node.

The input circuit part may include: a first-first transistor including a gate electrode connected to the clock node, a first electrode connected to the first input node, and a second electrode connected to a first buffer node; a first-second transistor including a gate electrode connected to the clock node, a first electrode connected to the first buffer node, and a second electrode connected to the first control node; a first-third transistor including a gate electrode connected to the first control node, a first electrode connected to a first power node to which a first gate voltage is applied, and a second electrode connected to the first buffer node; a second-first transistor including a gate electrode connected to the clock node, a first electrode connected to the second input node, and a second electrode connected to a second buffer node; a second-second transistor including a gate electrode connected to the clock node, a first electrode connected to the second buffer node, and a second electrode connected to the second control node; and a second-third transistor including a gate electrode connected to the second control node, a first electrode connected to the first power node, and a second electrode connected to the second buffer node.

The input circuit part may include: a first transistor including a gate electrode connected to the clock node, a first electrode connected to the first input node, and a second electrode connected to the first control node; and a second transistor including a gate electrode connected to the clock node, a first electrode connected to the second input node, and a second electrode connected to the second control node.

Each of the signal transmitters may further include: a second output node from which a second output signal having an inverted phase with respect to the first output signal is output. The output circuit part may include: a first output buffer, a second output buffer, a third output buffer, and a fourth output buffer that share the first control node and the second control node. The first output buffer may be configured to output a pulse of the first output signal via a first output node in response to charged voltages of the first control node and the second control node; the second output buffer may be configured to output a pulse of the first carry signal via a second output node in response to the charged voltages of the first control node and the second control node; the third output buffer may be configured to output a pulse of the second carry signal via a third output node in response to the charged voltages of the first control node and the second control node; and the fourth output buffer may be configured to output a pulse of the second output signal via a fourth output node in response to the charged voltages of the first control node and the second control node.

The first output buffer may include: a third transistor including a gate electrode connected to the first control node, a first electrode connected to a first power node to which a first gate voltage is applied, and a second electrode connected to the first output node; and a fourth transistor including a gate electrode connected to the second control node, a first electrode connected to the first output node, and a second electrode connected to a second power node to which a second gate voltage lower than the first gate voltage is applied. The second output buffer may include: a fifth transistor including a gate electrode connected to the first control node, a first electrode connected to the first power node, and a second electrode connected to the second output node; and a sixth transistor including a gate electrode connected to the second control node, a first electrode connected to the second output node, and a second electrode connected to a third power node to which a reference voltage lower than the second gate voltage is applied. The third output buffer may include: a seventh transistor including a gate electrode connected to the first control node, a first electrode connected to the third power node, and a second electrode connected to the third output node; and an eighth transistor including a gate electrode connected to the second control node, a first electrode connected to the third output node, and a second electrode connected to the first power node. The fourth output buffer may include: a ninth transistor including a gate electrode connected to the first control node, a first electrode connected to the second power node, and a second electrode connected to the fourth output node; and a tenth transistor including a gate electrode connected to the second control node, a first electrode connected to the fourth output node, and a second electrode connected to the first power node.

The output circuit part may include: a first capacitor connected between the first control node and the first output node; and a second capacitor connected between the first control node and the fourth output node.

The output circuit part may include: a first output buffer, a second output buffer, and a third output buffer that share the first control node and the second control node. The first output buffer may be configured to output a pulse of the first output signal via a first output node in response to charged voltages of the first control node and the second control node. The second output buffer may be configured to output a pulse of the first carry signal via a second output node in response to the charged voltages of the first control node and the second control node. The third output buffer may be configured to output a pulse of the second carry signal via a third output node in response to the charged voltages of the first control node and the second control node.

The first output buffer may include: a third transistor including a gate electrode connected to the first control node, a first electrode connected to a first power node to which a first gate voltage is applied, and a second electrode connected to the first output node; and a fourth transistor including a gate electrode connected to the second control node, a first electrode connected to the first output node, and a second electrode connected to a second power node to which a second gate voltage lower than the first gate voltage is applied. The second output buffer may include: a fifth transistor including a gate electrode connected to the first control node, a first electrode connected to the first power node, and a second electrode connected to the second output node; and a sixth transistor including a gate electrode connected to the second control node, a first electrode connected to the second output node, and a second electrode connected to a third power node to which a reference voltage lower than the second gate voltage is applied. The third output buffer may include: a seventh transistor including a gate electrode connected to the first control node, a first electrode connected to the third power node, and a second electrode connected to the third output node; and an eighth transistor including a gate electrode connected to the second control node, a first electrode connected to the third output node, and a second electrode connected to the first power node.

The output circuit part may include: a first capacitor connected between the first control node and the second output node; and a second capacitor connected between the second control node and the third output node.

According to yet another embodiment of the invention, a display device includes: a display panel in which a plurality of data lines, a plurality of gate lines, a plurality of pixels connected to the corresponding data lines and gate lines, and a gate driving circuit configured to output gate signals to the gate lines are provided. Each of the plurality of pixels receives at least a first gate signal as input. The gate driving circuit includes a plurality of signal transmitters to which a clock signal is applied. Each of the plurality of signal transmitters includes: a clock node to which the clock signal is input; a first input node to which a first input signal is input; a second input node to which a second input signal having an inverted phase with respect to the first input signal is applied; a first carry signal node to which a first carry signal is input; a second carry signal node to which a second carry signal having an inverted phase with respect to the first carry signal is input; and a first output node from which the first gate signal is output.

The first input signal may be a first start signal or a first carry signal that is output from a previous signal transmitter; and the second input signal may be a second start signal having an inverted phase with respect to the first start signal or a second carry signal that is output from the previous signal transmitter.

A pulse width of the first gate signal may be varied in proportion to a pulse width of the input signal.

Each of the plurality of pixels may be configured to receive a second gate signal having an inverted phase with respect to the first gate signal as input. Each of the plurality of signal transmitters may further include a second output node from which the second gate signal is output.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the inventive concepts.

FIG. 1 is a block diagram illustrating a display device according to an embodiment of the invention.

FIGS. 2 to 7 are diagrams illustrating pixel circuits that can be applied in embodiments of the invention and driving signals for the pixel circuits, where FIG. 2, FIG. 4, and FIG. 6 are circuit diagrams, and FIG. 3, FIG. 5, and FIG. 7 are waveform charts.

FIG. 8 is a diagram schematically illustrating a configuration of a gate driver according to the embodiment of the invention.

FIG. 9 is a circuit diagram illustrating a first embodiment of a signal transmitter illustrated in FIG. 8.

FIG. 10 is a circuit diagram illustrating a second embodiment of a signal transmitter illustrated in FIG. 8.

FIG. 11A, FIG. 11B, and FIG. 11C are waveform charts illustrating input/output signals and control node signals of the signal transmitters illustrated in FIGS. 9 and 10.

FIG. 12A, FIG. 12B, FIG. 13A, FIG. 13B, FIG. 14A, FIG. 14B, FIG. 15A, FIG. 15B, FIG. 16A, FIG. 16B, FIG. 17A, and FIG. 17B are diagrams illustrating an operation of the signal transmitter illustrated in each of FIGS. 9 and 10 in steps.

FIG. 18 and FIG. 19 are diagrams illustrating a configuration of a gate driver according to another embodiment of the invention.

### DETAILED DESCRIPTION

In the following description, for the purposes of explanation, numerous specific details are set forth in order to provide a thorough understanding of various embodiments or implementations of the invention. As used herein “embodiments” and “implementations” are interchangeable words that are non-limiting examples of devices or methods employing one or more of the inventive concepts disclosed herein. It is apparent, however, that various embodiments may be practiced without these specific details or with one or more equivalent arrangements. In other instances, well-known structures and devices are shown in block diagram form in order to avoid unnecessarily obscuring various embodiments. Further, various embodiments may be different, but do not have to be exclusive. For example, specific shapes, configurations, and characteristics of an embodiment may be used or implemented in another embodiment without departing from the inventive concepts.

As is customary in the field, some embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some embodiments may be physically separated into two or more interacting and discrete blocks, units, and/or modules without departing from the scope of the inventive concepts. Further, the blocks, units, and/or modules of some embodiments may be physically combined into more complex blocks, units, and/or modules without departing from the scope of the inventive concepts.

The advantages and features of the inventive concepts and methods for accomplishing the same will be more clearly understood from embodiments described below with reference to the accompanying drawings. However, the inventive concepts are not limited to the following embodiments but may be implemented in various different forms. Rather, the present embodiments will make the disclosure of the inventive concepts are complete and allow those skilled in the art to completely comprehend the scope of the inventive concepts.

The shapes, sizes, ratios, angles, numbers, and the like illustrated in the accompanying drawings for describing the embodiments of the invention are merely examples, and the inventive concepts are not limited thereto. Like reference numerals generally denote like elements throughout the present specification. Further, in describing the inventive concepts, detailed descriptions of known related technologies may be omitted to avoid unnecessarily obscuring the subject matter of the inventive concepts.

The terms such as “comprising,” “including,” “having,” and “consist of” used herein are generally intended to allow other components to be added unless the terms are used with the term “only.” Any references to singular may include plural unless expressly stated otherwise.

Components are interpreted to include an ordinary error range even if not expressly stated.

When a positional or interconnected relationship is described between two components, such as “on top of,” “above,” “below,” “next to,” “connect or couple with,” “crossing,” “intersecting,” or the like, one or more other components may be interposed between them, unless “immediately” or “directly” is used.

When a temporal antecedent relationship is described, such as “after”, “following”, “next to”, “before”, or the like, it may not be continuous on a time base unless “immediately” or “directly” is used.

The terms “first,” “second,” and the like may be used to distinguish elements from each other, but the functions or structures of the components are not limited by ordinal numbers or component names in front of the components.

The following embodiments can be partially or entirely bonded to or combined with each other and can be linked and operated in technically various ways. The embodiments can be carried out independently of or in association with each other.

Any implementation described herein as an “example” is not necessarily to be construed as preferred or advantageous over other implementations.

Also, when an element or layer is “connected,” “coupled,” or “adhered” to another element or layer denotes that the element or layer can not only be directly connected or adhered to the other element or layer, but also be indirectly connected or adhered to the other element or layer with one or more intervening elements or layers “disposed,” or “interposed” between the elements or layers, unless otherwise specified. It should be understood to mean that elements may be so disposed to directly contact each other, or may be so disposed without directly contacting each other.

The expression of a first element, a second elements “and/or” a third element should be understood as one of the first, second and third elements or as any or all combinations of the first, second and third elements. By way of example, A, B, and/or C can refer to only A; only B; only C; any or some combination of A, B, and C; or all of A, B, and C.

The term “at least one” should be understood as including any and all combinations of one or more of the associated listed items. For example, the meaning of “at least one of a first element, a second element, and a third element” encompasses the combination of all three listed elements, combinations of any two of the three elements, as well as each individual element, the first element, the second element, or the third element.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning for example consistent with their meaning in the context of the relevant art and should not be interpreted in an idealized or overly formal sense unless expressly so defined herein. For example, the term “part” or “unit” may apply, for example, to a separate circuit or structure, an integrated circuit, a computational block of a circuit device, or any structure configured to perform a described function as should be understood to one of ordinary skill in the art.

The pixel circuit and the gate drive circuit of the display device may include a plurality of transistors. The transistor may be implemented as a thin film transistor (TFT). The transistors may be implemented as an oxide thin film transistor (Oxide TFT) including an oxide semiconductor, a low temperature poly silicon TFT (LTPS TFT) including a low temperature poly silicon, and the like.

A transistor is a three-electrode element including a gate, a source, and a drain. The source is an electrode that supplies carriers to the transistor. In the transistor, carriers start to flow from the source. The drain is an electrode through which carriers exit from the transistor. In a transistor, carriers flow from a source to a drain. In the case of an n-channel transistor, since carriers are electrons, a source voltage is a voltage lower than a drain voltage such that electrons may flow from a source to a drain. The n-channel transistor has a direction of a current flowing from the drain to the source. In the case of a p-channel transistor (p-channel metal-oxide semiconductor, since carriers are holes, a source voltage is higher than a drain voltage such that holes may flow from a source to a drain. In the p-channel transistor, since holes flow from the source to the drain, current flows from the source to the drain. It should be noted that a source and a drain of a transistor are not fixed. For example, a source and a drain may be changed according to an applied voltage. Therefore, the inventive concepts are not limited to a source and a drain of a transistor. In the following description, a source and a drain of a transistor will be referred to as a first electrode and a second electrode.

A gate signal swings between a gate-on voltage and a gate-off voltage. A transistor is turned on in response to a gate-on voltage and is turned off in response to a gate-off voltage. In the case of an n-channel transistor, the gate-on voltage may be a gate high voltage, and the gate-off voltage may be a gate low voltage. In the case of a p-channel transistor, the gate-on voltage may be the gate low voltage, and the gate-off voltage may be the gate high voltage.

Hereinafter, various embodiments of the invention will be described in detail with reference to the accompanying drawings.

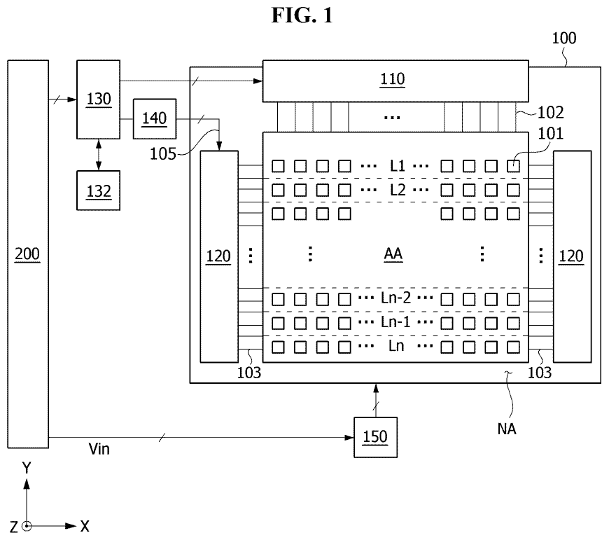

Referring to FIG. 1, the display device according to the embodiment of the invention includes a display panel 100, display panel driving circuits 110 and 120 that write pixel data to pixels 101 of the display panel 100, a power supply 150 that generates power necessary for driving the pixels 101 and the display panel driving circuits 110 and 120, and the like.

The display panel 100 may be a rectangular panel having a breath (or a width) in the X-axis direction, a length in the Y-axis direction, and a thickness in the Z-axis direction, but is not limited thereto. A screen of the display panel 100 may include a display area AA and a non-display area outside the display area AA. The display area AA of the display panel 100 includes a pixel array that displays an input image. The pixel array includes a plurality of data lines 102, a plurality of gate lines 103 intersecting the data lines 102, and pixels provided in a matrix. The display panel 100 may further include power lines connected in common to two or more pixels. The power lines may be connected in common to pixel circuits and may supply voltages necessary for driving the pixels 101 to the pixels 101.

The data lines 102 are provided in the form of long wires along the Y-axis direction of the display panel 100 and are electrically connected to data channels of a data driver 110. The gate lines 103 are provided in the form of long wires along the X-axis direction of the display panel 100, intersect the data lines 102, and are electrically connected to output terminals of a gate driver 120.

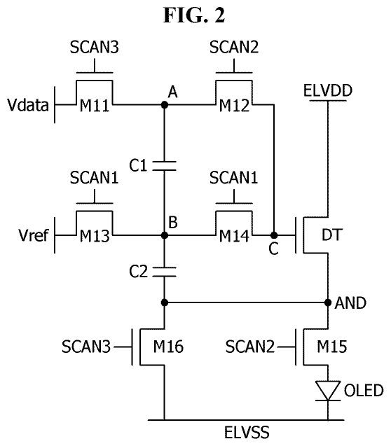

Each of the pixels 101 may be divided into a red sub-pixel, a green sub-pixel, and a blue sub-pixel for color implementation. Each of the pixels may further include a white sub-pixel. Each of the sub-pixels includes a pixel circuit for driving a light-emitting element. Each of the pixel circuits is connected to the data line, the gate lines, and the power lines. The pixel circuit may be implemented as a circuit illustrated in FIGS. 2, 4, 6, or the like, but is not limited thereto.

The pixel array includes a plurality of pixel lines L1 to Ln. Each of the pixel lines L1 to Ln includes pixels of one line provided along the X-axis direction in the pixel array of the display panel 100. The pixels provided in one pixel line share the gate lines 103. The sub-pixels provided in the Y-axis direction along the data line share the same data line 102. One horizontal period 1 H may be a time obtained by dividing one frame period by the total number of pixel lines L1 to Ln.

The display panel 100 may be implemented as a non-transmissive display panel or a transmissive display panel. The transmissive display panel may be applied to a transparent display device in which an image is displayed on a screen and a real object outside the display panel is visible. The display panel 100 may be manufactured as a flexible display panel.

The power supply 150 adjusts a level of a voltage Vin input from a main power supply of the host system 200 and outputs voltages necessary for driving the pixel array of the display panel 100 and the display panel driving circuit. The power supply 150 may include a DC-DC converter. The DC-DC converter may include a charge pump, a regulator, a buck converter, a boost converter, and the like. The power supply 150 may output a gamma reference voltage, a gate high voltage, a gate low voltage, a reference voltage, a pixel driving voltage, a pixel ground voltage, a pixel compensation voltage, an integrated circuit (IC) driving voltage, and the like through the DC-DC converter. The voltages that are output from the power supply 150 may be constant voltages (or direct-current voltages), but are not limited thereto. The gamma reference voltage is supplied to the data driver 110. A dynamic range of a data voltage that is output from the data driver 110 is determined according to a voltage range of the gamma reference voltage. The dynamic range of the data voltage has a voltage range between a highest grayscale voltage and a lowest grayscale voltage.

The gate high voltage and the gate low voltage are supplied to a level shifter 140 and the gate driver 120. The voltages such as the pixel driving voltage, the pixel ground voltage, and the reference voltage are supplied to the pixels 101. The IC driving voltage is a driving voltage of a drive IC embedded with circuits such as a timing controller 130 and the data driver 110.

The timing controller 130 may be implemented as an application-specific integrated circuit (ASIC), and the power supply 150 may be implemented as a power IC such as a power management integrated circuit (PMIC) or an electronics integrated circuit (ELIC).

The display panel driving circuits 110 and 120 write pixel data of an input image to the pixels of the display panel 100 under the control of the timing controller 130. The display panel driving circuits 110 and 120 include the data driver 110 and the gate driver 120. The display panel driving circuits 110 and 120 may further include de-multiplexers (DEMUX) provided between the data driver 110 and the data lines 102, but embodiments of the invention are not limited thereto. When the de-multiplexers are provided between output terminals of the data driver 110 and the data lines 102, the number of channels (or the number of output terminals) of the data driver 110 may be reduced.

Touch sensors for sensing a touch input may be provided on the display panel 100. The touch sensors may be provided on the display panel 100 as an on-cell type or an add-on type, or may be implemented as in-cell type touch sensors embedded in the pixel array.

The display panel driving circuits 110 and 120 may further include a touch sensor driver for driving the touch sensors. The touch sensor driver is not shown in FIG. 1. The data driver 110 and the touch sensor driver may be integrated in one drive IC.

The data driver 110 is electrically connected to the data lines 102 and outputs a data voltage corresponding to pixel data of the input image. Each of the channels of the data driver 110 receives pixel data of the input image received as a digital signal transmitted from the timing controller 130 as input and outputs the data voltage.

The channels of the data driver 110 may convert pixel data DATA of the input image received from the timing controller 130 into a gamma compensation voltage using a digital to analog converter (hereinafter, referred to as “DAC”) and may output the data voltage of the pixel data. The data driver 110 may divide the gamma reference voltage input from the power supply 150 into gamma compensation voltages having different voltage levels by grayscale using a voltage distribution circuit (or a voltage division circuit). The gamma compensation voltages are supplied to the DAC of the data driver 110. The data voltage is output from each of the channels of the data driver 110 via an output buffer.

The gate driver 120 may be provided on at least one non-display area NA of right and left sides outside the display area AA in the display panel 100 or at least a part of the gate driver 120 may be provided in the display area AA.

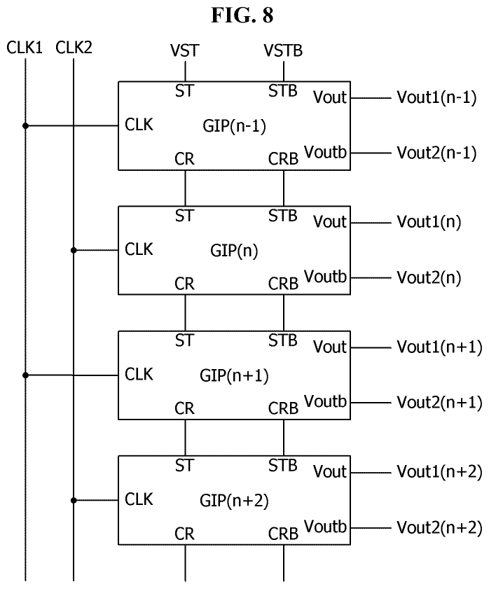

The gate driver 120 may be provided in the non-display areas NA on both sides of the display panel 100 with the display area AA of the display panel interposed therebetween and may supply gate pulses on both sides of the gate lines 103 by a double feeding method. The gate driver 120 sequentially outputs pulses of gate signals to the gate lines 103 under the control of the timing controller 130. The gate driver 120 may sequentially supply the gate signals to the gate lines 103 by shifting the pulses of the gate signals using a shift register or an edge trigger. The gate driver 120 may include a plurality of gate drivers. At least one of the plurality of gate drivers may be implemented as a gate driving circuit (or a shift register circuit) as in FIGS. 8 to 10, and FIGS. 18 and 19. At least one of other gate drivers may be implemented as an edge trigger, but is not limited thereto.

The timing controller 130 receives pixel video data of an input image and timing signal and a timing signal synchronized with the data from the host system 200. The timing signal may include a vertical synchronization signal Vsync, a horizontal synchronization signal Hsync, a data enable signal DE, and the like. Since a vertical period and a horizontal period can be known by a method of counting the data enable signal DE, the vertical synchronization signal Vsync and the horizontal synchronization signal Hsync may be omitted. The horizontal synchronization signal Hsync and the data enable signal DE have a cycle of one horizontal period 1 H. A data voltage of pixel data may be charged simultaneously in sub-pixels provided in one pixel line in one horizontal period 1 H and pixel data may be written to the sub-pixels.

The timing controller 130 generates a data timing control signal for controlling an operation timing of the data driver 110 and a gate timing control signal for controlling an operation timing of the gate driver 120 on the basis of the timing signal (Vsync, Hsync, DE) received from the host system 200. The timing controller 130 controls an operation timing of the display panel driving circuit to synchronize the data driver 110 and the gate driver 120. The vertical synchronization signal Vsync defines one frame period. One pulse cycle of the horizontal synchronization signal Hsync and the data enable signal DE is one horizontal period 1 H. The data enable signal DE defines a valid data interval in which pixel data of an input image is present.

The gate timing control signal output from the timing controller 130 may be input to the shift register and/or the edge trigger of the gate driver 120 via the level shifter 140. The level shifter 140 may convert the gate timing control signal received from the timing controller 130 via clock lines 105 to have a swing width between the gate high voltage and the gate low voltage and may provide the converted gate timing control signal to the gate driver 120. The gate timing control signal that is output from the level shifter 140 may include a start signal, a clock, and the like, but is not limited thereto. The gate driver 120 may output pulses of gate signals for writing pixel data to the sub-pixels during a display period in response to the gate timing control signal input from the level shifter 140.

The display panel driving circuits 110 and 120 may drive the pixels 101 at a variable refresh rate (VRR) under the control of the timing controller 130. The timing controller 130 may count the input timing signal (Vsync, HE, DE) by the clock to determine a refresh rate of an input image in real time. The timing controller 130 may decrease a refresh rate of an image that is displayed on the display panel 100, according to a frequency of the input image or on the basis of a result of analyzing the input image, thereby reducing the power consumption of the display device and improving image quality. The variable refresh rate may vary a refresh driving frequency of the pixels to 1 Hz, 30 Hz, 60 Hz, 120 Hz, 144 Hz, 165 Hz, 240 Hz, and the like, but embodiments of the invention are not limited thereto.

The variable refresh rate varies a frame refresh rate per second of an image that is reproduced on the screen of the display panel 100, in real time, instead of maintaining the frame refresh rate per second to a fixed value. In displaying an image of contents such as a game or an animation on the display panel 100, the display panel driving circuits 110 and 120 may adjust a refresh driving frequency of the display panel 100 in conformity with frames per second (FPS) of the image under the control of the timing controller 130, thereby reducing a problem such as tearing or stuttering of the image that is reproduced on the screen of the display panel 100.

The pixels are charged with a data voltage of pixel data in conformity with the frames per second (FPS) varying in real time according to the variable refresh rate. The unit of the variable refresh rate is hertz (Hz). When the refresh rate is 60 Hz, pixel data is written to the pixels for each frame period of 60 frames per second, and when the refresh rate increases to 120 Hz, pixel data is written to the pixels for each frame period of 120 frames per second. In a display device that supports a variable refresh rate, a refresh driving frequency of pixels at which pixel data is written to the pixels changes according to the variable refresh rate.

The display panel driving circuits 110 and 120 may reduce power consumption of the display device by decreasing the refresh rate of the pixels 101 when a still image is input for a given time or more under the control of the timing controller 130, and may implement image quality as optimum image quality for the contents of the input image by increasing the refresh driving frequency of the pixels according to the refresh rate of the input image. The refresh rate may be decreased when the display device operates in a standby mode or in response to a user's command. The refresh rate may be decreased on an “always on” display (AOD) screen. The AOD screen may be a partial pixel area of the display area AA where preset information, for example, brief information, such as a remaining battery quantity and time, is displayed in the standby mode.

The host system 200 may convert the resolution of an image signal from a video source in conformity with the resolution of the display panel 100 and may transmit the converted image signal to the timing controller 130 along with the timing signal.

A memory 132 may store driving setting timing information of the display panel driving circuits 110 and 120, program codes of a compensation algorithm for improving image quality, and the like. The memory 132 may include a nonvolatile memory and a volatile memory. The nonvolatile memory may include one or more of readable and writable memories, for example, a NAND flash memory, a NOR flash memory, and an electrically erasable programmable read-only memory (EEPROM). The NAND flash memory may be a single level cell (SLC) type. The volatile memory may include one or more of a dynamic RAM (DRAM), a static RAM (SRAM), a synchronous dynamic RAM (SDRAM), and a double data rate SDRAM (DDR SDRAM).

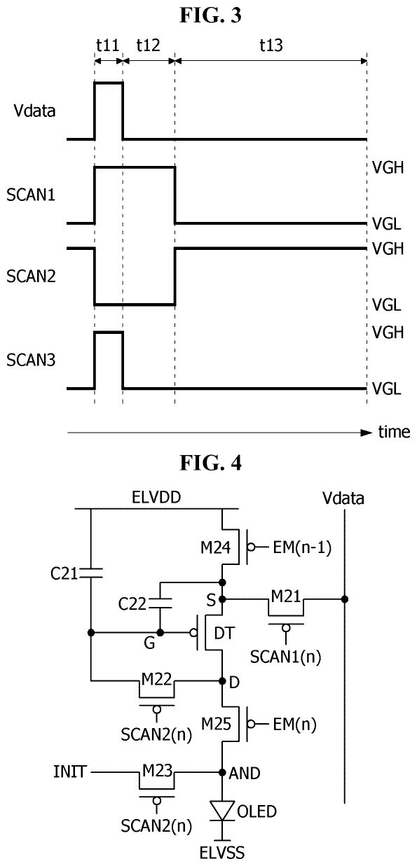

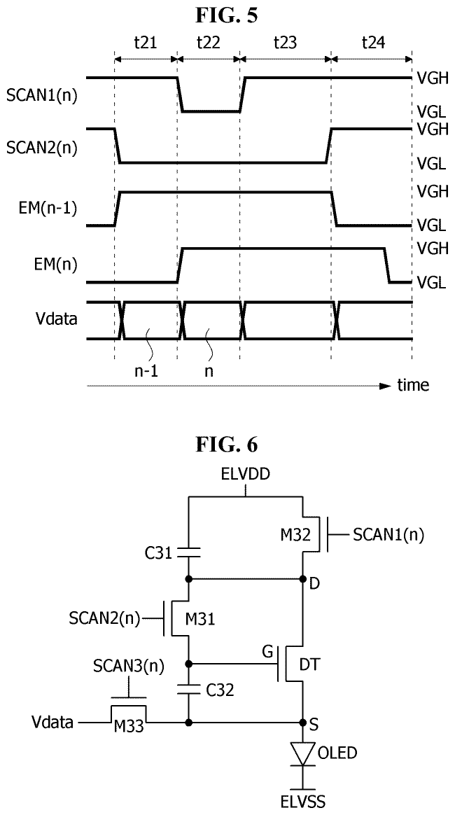

The gate driver 120 may output multiple gate signals having different waveforms as illustrated in FIGS. 3 and 5. The gate signals that are input to the pixel circuit may include scan signals SCAN1 to SCAN3, an emission control signal (hereinafter, referred to as an “EM signal”), and the like illustrated in FIGS. 2 to 6, but embodiments of the invention are not limited thereto.

FIG. 2 is a circuit diagram illustrating a pixel circuit according to a first embodiment of the invention. FIG. 3 is a waveform chart illustrating driving signals of the pixel circuit illustrated in FIG. 2.

Referring to FIGS. 2 and 3, the pixel circuit includes a light-emitting element OLED, a driving element DT that drives the light-emitting element OLED, a plurality of switch elements M11 to M16, a first capacitor C1, and a second capacitor C2. Each of the driving element DT and the switch elements M11 to M16 may be implemented as an n-channel oxide TFT having characteristics of low cost and low off current. As an example of a material for a semiconductor layer of the n-channel oxide TFT, amorphous indium-gallium-zinc oxide (a-IGZO) may be used, but embodiments of the invention are not limited thereto.

The driving element DT includes a gate electrode connected to a third node C, a first electrode connected to a power line to which a pixel driving voltage ELVDD is applied, and a second electrode connected to a fourth node AND. The light-emitting element OLED includes an anode electrode connected to the fourth node AND and a cathode electrode connected to a power line to which a pixel ground voltage ELVSS is applied. The light-emitting element OLED may be driven by a current that is generated according to a gate-source voltage Vgs of the driving element DT and may emit light with luminance corresponding to a grayscale value of pixel data.

The first capacitor C1 is connected between a first node A and a second node B. The second capacitor C2 is connected between the second node B and the fourth node AND.

A first switch element M11 is connected between the first node A and a data line to which a data voltage Vdata of pixel data is applied, and is turned on in response to a gate high voltage VGH of a third scan signal SCAN3. When the first switch element M11 is turned on, the data voltage Vdata may be applied to the first node A. A second switch element M12 is connected between the first node A and the third node C, and is turned on in response to a gate high voltage VGH of a second scan signal SCAN2. When the second switch element M12 is turned on, the first node A may be electrically connected to the third node C.

A third switch element M13 is connected between the second node B and a power line to which a reference voltage Vref is applied, and is turned on in response to a gate high voltage VGH of a first scan signal SCAN1 (FIG. 3). When the third switch element M13 is turned on, the second node B may be electrically connected to the power line to which the reference voltage Vref is applied. A fourth switch element M14 is connected between the second node B and the third node C, and is turned on in response to the gate high voltage VGH of the first scan signal SCAN1. When the fourth switch element M14 is turned on, the second node B may be electrically connected to the third node C.

A fifth switch element M15 is connected between the fourth node AND and the anode electrode of the light-emitting element OLED, and is turned on in response to the gate high voltage VGH of the second scan signal SCAN2. When the fifth switch element M15 is turned on, the fourth node AND may be electrically connected to the anode electrode of the light-emitting element OLED. A sixth switch element M16 is connected between the fourth node AND and the power line to which the pixel ground voltage ELVSS is applied, and is turned on in response to the gate high voltage VGH of the second scan signal SCAN2. When the sixth switch element M16 is turned on, the fourth node AND may be electrically connected to the power line of the pixel ground voltage ELVSS.

In one frame period during which pixel data is written to sub-pixels, a driving period of the pixel circuit illustrated in FIG. 2 may be divided into a first period t11, a second period t12, and a third period t13, as shown in FIG. 3.

In the first period t11, initialization and pixel data writing are performed. In the first period t11, the first, third, fourth, and sixth switch elements M11, M13, M14, and M16 are turned on, the data voltage Vdata is charged in the first capacitor C1, and the reference voltage Vref is charged in the second capacitor C2.

In the second period t12, a threshold voltage Vth of the driving element DT is compensated for. In the second period t12, the first and sixth switch elements M11 and M16 are turned off in response to a gate low voltage VGL of the third scan signal SCAN3. In this case, the threshold voltage Vth of the driving element DT is sampled and stored in the second capacitor C2. The second period t12 allows a current flowing into the light-emitting element OLED in an emission step of the light-emitting element OLED, which will be performed in the third period t13, to flow uniformly without being affected by fluctuation of the threshold voltage Vth.

In the third period t13, the light-emitting element OLED is driven by the current generated by the driving element DT. In the third period t13, a voltage of the first scan signal SCAN1 is changed to the gate low voltage VGL, and the third switch element M13 is turned off. Meanwhile, a voltage of the second scan signal SCAN2 is inverted to the gate high voltage VGH, and the second and fifth switch elements M12 and M15 are turned on. In this case, the light-emitting element OLED may emit light with luminance corresponding to the grayscale value of the pixel data.

To normally operate the pixel circuit illustrated in FIG. 2, the gate driver 120 typically outputs the gate signals SCAN1 and SCAN2 having opposite phases. A separate inverter circuit may be connected to an output terminal of a shift register such that the signals having inverted phases are output from the gate driver 120. Because the inverter circuit that is connected to the output terminal of the shift register is implemented using a plurality of transistors, the size of the gate driver 120 on the display panel 100 is increased. To connect the inverter circuit to an output end of the gate driver 120, an LTPS-based p-channel TFT is inevitably used. For this reason, a semiconductor process and a photomask process are additionally required in the display panel 100. When the inverter circuit is implemented using n-channel oxide TFTs only, the threshold voltage Vth may be shifted to a negative polarity (Vth negative shift) due to accumulation of stress of the TFTs in the inverter circuit. Because a current may flow due to a depletion mode characteristic of the oxide TFT when a gate voltage Vg is Vg <0 [V], an appropriate preparation is required. When a compensation circuit is additionally provided in consideration of this situation, the size of the circuit is further increased. In the gate driver 120, the gate signals having inverted phases may be generated by a method in which a shift register to which a start pulse having an inverted phase is connected to the output terminal of the shift register. However, this causes the circuit size of the gate driver 120 to be further increased.

In the embodiment of the invention, gate signals having opposite phases may be output using a single shift register without an inverter circuit by implementing the gate driver 120 as a pulse width modulation (PWM) shift register illustrated in FIGS. 8 to 10 and FIGS. 18 and 19. This shift register can improve the circuit size, reliability, and power consumption of the gate driver 120. Because an inverter circuit is not provided in the gate driver 120, the circuit configuration is simple, and the circuit size is small. Further, because there are no power consumption, heat generation, and TFT deterioration in an inverter circuit, reliability can be improved. In addition, because the size of the gate driver 120 on the display panel 100 is reduced, the size of the non-display area NA outside the display area AA is reduced, and the design for a narrow bezel is facilitated.

FIG. 4 is a circuit diagram illustrating a pixel circuit according to a second embodiment of the invention. This pixel circuit is an example of a low-temperature polycrystalline silicon (LTPS) TFT-based pixel circuit. FIG. 5 is a waveform chart illustrating driving signals of the pixel circuit illustrated in FIG. 4. In FIG. 5, “n−1” and “n” denoted in the data voltage Vdata represent data voltages that are applied to sub-pixels of an (n−1)th pixel line and sub-pixels of an n-th pixel line, respectively.

Referring to FIGS. 4 and 5, the pixel circuit includes a light-emitting element OLED, a driving element DT that drives the light-emitting element OLED, a plurality of switch elements M21 to M25, a first capacitor C21, and a second capacitor C22. Each of the driving element DT and the switch elements M21 to M25 may each be implemented as a p-channel LTPS TFT. Each of the driving element DT and the switch elements M21 to M25 is turned on in response to the gate low voltage VGL and is turned off in response to the gate high voltage VGH.

The driving element DT includes a gate electrode connected to a first node G, a first electrode connected to a second node S, and a second electrode connected to a third node D. The light-emitting element OLED includes an anode electrode connected to the fourth node AND, and a cathode electrode connected to a power line to which a pixel ground voltage ELVSS is applied. The first capacitor C21 is connected between the first node G and a power line to which a pixel driving voltage ELVDD is applied. The second capacitor C22 is connected between the first node G and the second node S.

A first switch element M21 is connected between the second node S and a data line to which a data voltage Vdata of pixel data is applied, and is turned on in response to a gate low voltage VGL of a first scan signal SCAN1(n). When the first switch element M21 is turned on, the data voltage Vdata may be applied to the second node S. A second switch element M22 is connected between the first node G and the third node D, and is turned on in response to a gate low voltage VGL of a second scan signal SCAN2(n). When the second switch element M22 is turned on, the first node G may be electrically connected to third node D.

A third switch element M23 is connected between the fourth node AND and a power line to which an initialization voltage INIT is applied, and is turned on in response to the gate low voltage VGL of the second scan signal SCAN2(n). When the third switch element M23 is turned on, the fourth node AND may be electrically connected to the power line to which the initialization voltage INIT is applied. A fourth switch element M24 is connected between the second node S and the power line to which the pixel driving voltage ELVDD is applied, and is turned on in response to a gate low voltage VGL of an (n−1)th EM signal EM(n−1). When the fourth switch element M24 is turned on, the pixel driving voltage ELVDD is applied to the second node S. A fifth switch element M25 is connected between the third node D and the fourth node AND, and is turned on in response to a gate low voltage VGL of an n-th EM signal EM(n). When the fifth switch element M15 is turned on, the third node D may be electrically connected to the fourth node AND.

In one frame period during which pixel data is written to sub-pixels, a driving period of the pixel circuit illustrated in FIG. 4 may be divided into a first period t21, a second period t22, a third period t23, and a fourth period t24, as shown in FIG. 5.

The first period t21 is an initialization step. In the first period t21, the second, third, and sixth switch elements M22, M23, and M25 are turned on, and primary nodes are initialized. The first and fourth switch elements M21 and M24 are turned off in the first period t21. In this case, the driving element DT is turned on according to an initialized gate voltage.

The second period t22 is a programming step in which the threshold voltage Vth of the driving element DT is sampled with the data voltage Vdata. In the second period t22, while the first, second, and third switch elements M21, M22, and M23 are turned on, the fourth and fifth switch elements M24 and M25 are turned off. In the second period t22, the data voltage Vdata is transmitted to the second node S, and the driving element DT is driven in a diode connection state. As a result, when the second period t22 ends, the threshold voltage Vth of the driving element DT is sampled and stored in the first capacitor C21.

The third period t23 is a compensation step in which a current error of the light-emitting element OLED is reduced by compensating for a change in subthreshold slope (SS) of the driving element DT. In the third period t23, the second and third switch elements M22 and M23 are maintained in an on state, and the first, fourth, and fifth switch elements M21, M24, and M25 are turned off. The driving element DT is in the diode connection state in the third period t23, and a current flows in the channel of the driving element DT in a subthreshold area. In this process, the influence of the subthreshold slope can be compensated for, and the gate voltage can be adjusted.

The fourth period t24 is an emission step. In the fourth period t24, the first, second, and fourth switch elements M21, M22, and M24 are turned off, and the fourth and fifth switch elements M24 and M25 are turned on. Accordingly, the light-emitting element OLED is driven by a current that is generated through the driving element DT. In the fourth period t24, the capacitors C21 and C22 are connected in parallel via the fourth switch element M24. As a result, the storage capacity is increased, and the fluctuation of the gate voltage can be suppressed.

To normally operate the pixel circuit illustrated in FIG. 4, the gate driver 120 typically outputs the gate signals SCAN2(n) and EM(n−1) having opposite phases. In the embodiment of the invention, the gate signals SCAN2(n) and EM(n−1) having opposite phases can be output using the shift register illustrated in FIGS. 8 to 10 and FIGS. 18 and 19 without an inverter circuit.

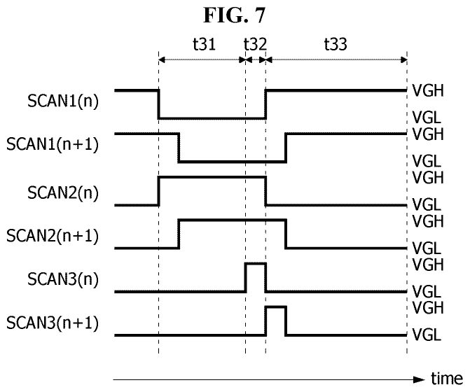

FIG. 6 is a circuit diagram illustrating a pixel circuit according to a third embodiment of the invention. FIG. 7 is a waveform chart illustrating driving signals of the pixel circuit illustrated in FIG. 6.

Referring to FIGS. 6 and 7, the pixel circuit includes a light-emitting element OLED, a driving element DT that drives the light-emitting element OLED, a plurality of switch elements M31, M32, and M33, a first capacitor C31, and a second capacitor C32. Each of the driving element DT and the switch elements M31, M32, and M33 may be implemented as an n-channel oxide TFT.

The driving element DT includes a gate electrode connected to a first node G, a first electrode connected to a second node D, and a second electrode connected to a third node S. The light-emitting element OLED includes an anode electrode connected to the third node S, and a cathode electrode connected to a power line to which a pixel ground voltage ELVSS is applied. The first capacitor C31 is connected between the second node D and a power line to which a pixel driving voltage ELVDD is applied. The second capacitor C32 is connected between the first node G and the third node S.

A first switch element M31 is connected between the first node G and the second node D, and is turned on in response to a gate high voltage VGH of a second scan signal SCAN2(n). When the first switch element M31 is turned on, the second node D is electrically connected to the first node G, and the driving element DT is driven as a diode. A second switch element M32 is connected between the second node D and the power line to which the pixel driving voltage ELVDD is applied, and is turned on in response to a gate high voltage VGH of a first scan signal SCAN1(n). When the second switch element M32 is turned on, the pixel driving voltage ELVDD is applied to the second node D. A third switch element M33 is connected between the third node S and a data line to which a data voltage Vdata is applied, and is turned on in response to a gate high voltage VGH of a third scan signal SCAN3(n). When the third switch element M33 is turned on, the data voltage Vdata is applied to the third node S.

In one frame period during which pixel data is written to sub-pixels, a driving period of the pixel circuit illustrated in FIG. 6 may be divided into a first period t31, a second period t32, and a third period t33, as shown in FIG. 7.

The first period t31 is a compensation step in which the threshold voltage Vth of the driving element DT is sampled and a change in the threshold voltage Vth of the light-emitting element OLED is compensated for. In the first period t31, the voltages of the first and third scan signals SCAN1(n) and SCAN3(n) are the gate low voltage VGL, and the voltage of the second scan signal SCAN2(n) is the gate high voltage VGH. Accordingly, in the first period t31, the first switch element M31 is turned on, and the second and third switch elements M32 and M32 are turned off.

The second period t32 is a step in which the data voltage Vdata is charged. In the second period t32, the first and second scan signals SCAN1(n)) and SCAN2(n) are maintained in the previous state, and the third scan signal SCAN3(n) has the gate high voltage VGH. Accordingly, in the second period t32, the third switch element M33 is turned on, and the data voltage is applied to the third node S. In this case, the threshold voltage of the driving element DT and mobility can be compensated for by voltages charged in the capacitors C31 and C32.

The third period t33 is an emission step. In the third period t33, the voltage of the first scan signal SCAN1(n) is inverted to the gate high voltage VGH. In the third period t33, the light-emitting element OLED may emit light due to a current flowing through the channel of the driving element DT in a state in which the threshold voltage of the driving element DT and mobility are compensated for.

As illustrated in FIG. 4, the gate signals SCAN2(n) and EM(n−1) having opposite phases are required for the pixel circuit. To normally operate the pixel circuit illustrated in FIG. 6, the gate signals SCAN1(n) and SCAN2(n) having opposite phases are required. In the embodiment of the invention, it is possible to output gate signals having opposite phases using the shift register illustrated in FIGS. 8 to 10 and FIGS. 18 and 19.

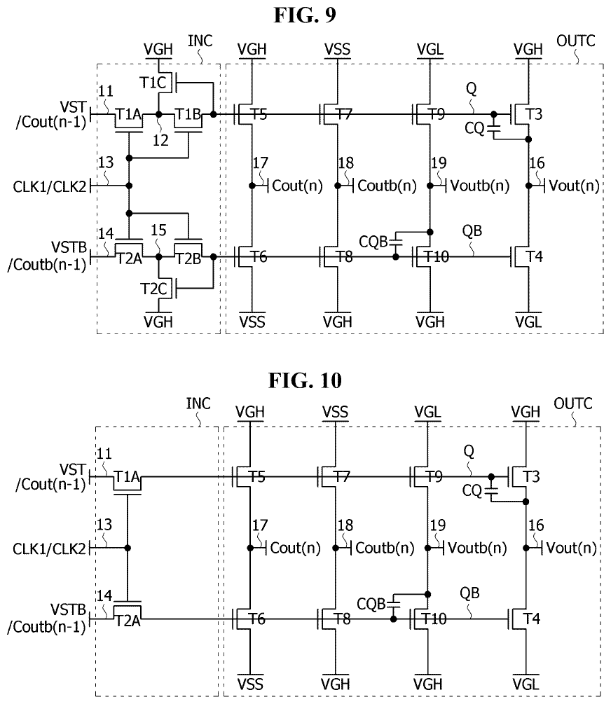

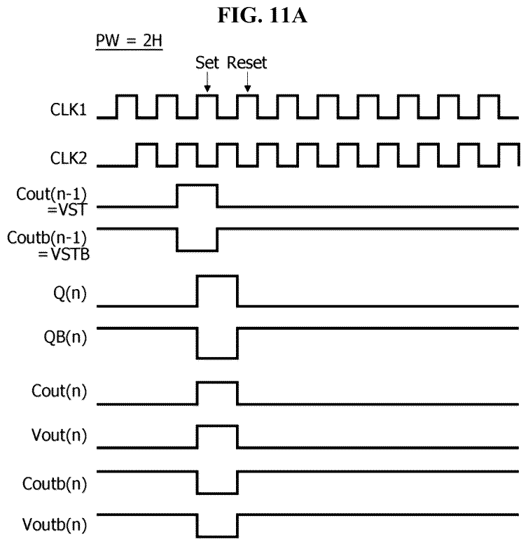

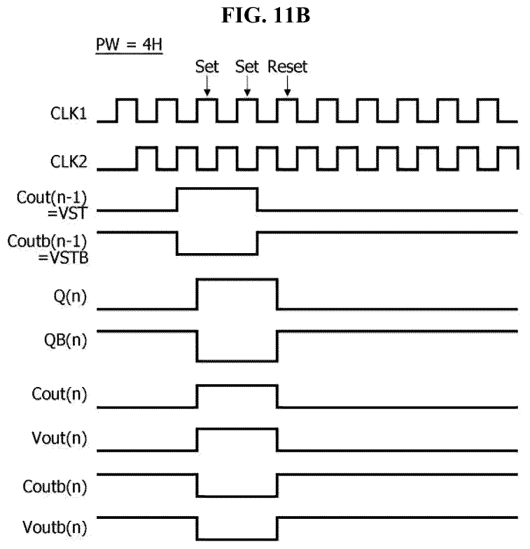

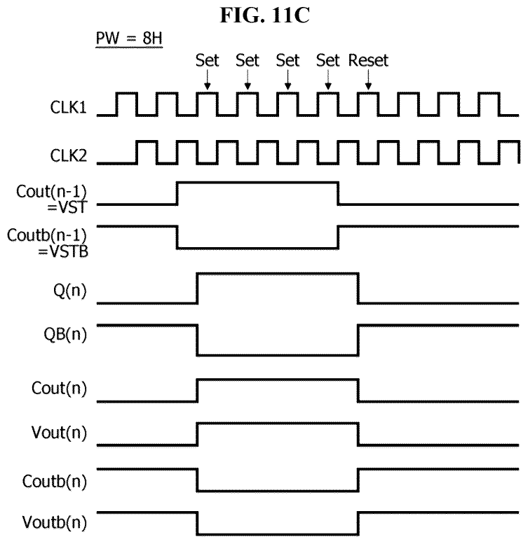

FIG. 8 is a diagram schematically illustrating a configuration of a gate driver according to the embodiment of the invention. FIG. 9 is a circuit diagram illustrating a first embodiment of a signal transmitter illustrated in FIG. 8. FIG. 10 is a circuit diagram illustrating a second embodiment of a signal transmitter illustrated in FIG. 8. FIGS. 11A to 11C are waveform charts illustrating voltages of input/output signals and control node signals of the signal transmitters illustrated in FIGS. 9 and 10. In FIGS. 8 to 11C, “Vout1, Vout2, Vout, Voutb” are output signals that are output from the gate driver 120. In FIGS. 11A to 11C, “Set” represents a set step in which a first control node Q is charged to the gate high voltage VGH or more, and “Reset” represents a reset step in which a second control node QB is charged to the gate high voltage VGH or more.

Referring to FIGS. 8 to 11C, the gate driver 120 includes a shift register in which signal transmitters GIP(n−1), GIP(n), GIP(n+1), and GIP(n+2) are connected in a cascade manner via clock lines and carry signal lines. Each of the signal transmitters GIP(n−1) to GIP(n+2) includes a first input node ST, a second input node STB, a clock node CLK, a first carry signal node CR, a second carry signal node CRB, a first output node Vout, and a second output node Voutb.

A first start signal VST is input to a first input node ST of a first signal transmitter, for example, an (n−1)th signal transmitter GIP(n−1). A second start signal VSTB is input to a second input node STB of the first signal transmitter, for example, the (n−1)th signal transmitter GIP(n−1). The signal transmitters GIP(n−1) to GIP(n+2) output first output signals Vout1(n−1) to Vout(n+2) (Vout(n)) and second output signals Vout2(n−1) to Vout2(n+2) (Voutb(n)) having inverted phases via the output nodes Vout and Voutb, and output first carry signals Cout(n) and second carry signals Coutb(n) via the carry signal nodes CR and CRB.

The signal transmitters GIP(n−1) to GIP(n+2) receive, as input, the first start signal VST, the second start signal VSTB, a first clock CLK1, and a second clock CLK2 from the level shifter 140 via the clock lines 105 illustrated in FIG. 1.

The first start signal VST and the second start signal VSTB are clocks having inverted phases as will be understood from FIGS. 11A to 11C. The pulses of the first start signal VST and the second start signal VSTB may be generated once at the beginning of a frame period for each frame period, but embodiments of the invention are not limited thereto. The first carry signal Cout(n−1) and the second carry signal Coutb(n−1) illustrated in FIGS. 11A to 11C are clocks having inverted phases. The first start signal VST and the second start signal VSTB are input to the corresponding input nodes ST and STB in the first signal transmitter with the same waveforms as the first carry signal Cout(n−1) and the second carry signal Coutb(n−1) as will be understood from FIGS. 11A to 11C.

The first clock CLK1 and the second clock CLK2 are clocks having inverted phases as illustrated in FIGS. 11A to 11C. A pulse cycle of each of the first clock CLK1 and the second clock CLK2 is smaller than that of each of the start signals VST and VSTB and that of each of the carry signals Cout(n−1) and Coutb(n−1) as will be understood from FIGS. 11A to 11C. The first clock CLK1 may be input to an odd-numbered signal transmitter, and the second clock CLK2 may be input to an even-numbered signal transmitter, but embodiments of the invention are not limited thereto. The output signals Vout1(n−1) to Vout2(n+2) (Vout(n) and Voutb(n)) that are output from the shift register may be delayed with respect to the pulses of the start signals VST and VSTB by one pulse width of the clock signals CLK1 and CLK2.

The first clock CLK1 and the second clock CLK2 may have a pulse cycle of two horizontal periods 2 H and a pulse width of one horizontal period 1 H. The output signals Vout1(n−1) to Vout2(n+2) (Vout(n) and Voutb(n)) that are output from the shift register may be delayed with respect to the start signals VST and VSTB by one pulse width of the clocks CLK1 and CLK2.

In FIGS. 11A to 11C, PW=2 H, PW=4 H, and PW=8 H represent an example where the pulse widths PW of the start signals VST and VSTB having opposite phases are varied to two horizontal periods 2 H, four horizontal periods 4 H, and eight horizontal periods 8 H. The shift register illustrated in each of FIGS. 9 and 10 may adjust the pulse widths of the output signals Vout1(n−1) to Vout2(n+2) (Vout(n) and Voutb(n)) according to the pulse widths PW of the start signals VST and VSTB. The pulse widths of the output signals Vout1(n−1) to Vout2(n+2) (Vout(n) and Voutb(n)) that are output from the shift register are substantially the same as the pulse widths PW of the start signals VST and VSTB.

As will be understood from FIGS. 9 and 10, the signal transmitter includes a structure resistant to a leakage current without an inverter circuit. For this reason, the signal transmitter can have a simple circuit configuration and minimize or reduce power consumption.

Referring to FIG. 9, the signal transmitter includes an input circuit part INC and an output circuit part OUTC.

The input circuit part INC includes a first input node 11 to which a first input signal is input, a second input node 14 to which a second input signal is input, a clock node 13 to which the clock signal CLK1 or CLK2 is input, a power node to which the gate high voltage VGH is applied, and a plurality of transistors T1A to T2C. The first input signal is the first start signal VST or the first carry signal Cout(n−1). The second input signal is the second start signal VSTB or the second carry signal Coutb(n−1). Each of the transistors T1A to T2C may be implemented as an n-channel oxide TFT. The phases of the first input signal VST/Cout(n) and the second input signal VSTB/Coutb(n) may be opposite to each other. Hereinafter, the operation of the signal transmitter will be described assuming that the first clock signal CLK1 is input to the clock node 13.

The output circuit part OUTC includes first and second control nodes Q and QB connected to the input circuit part INC, a plurality of power nodes to which the gate high voltage VGH, the gate low voltage VGL, and a first low-potential reference voltage VSS are applied, and a plurality of transistors T5 to T10 that are controlled according to voltages of the control nodes Q and QB. Each of the transistors T5 to T10 may be implemented as an n-channel oxide TFT.

The voltages of the start signals VST and VSTB, the carry signals Cout(n−1), Cout(n), Coutb(n−1), and Coutb(n), the clock signals CLK1 and CLK2, and the output signals Vout(n) and Voutb(n) that are input to the signal transmitter illustrated in FIG. 9 swing between the gate high voltage VGH and the gate low voltage VGL. The power supply voltages that are input to the signal transmitter illustrated in FIG. 9 may have a relationship of VGH>VGL>VSS. For example, VGH=10 [V], VGL=−10 [V], and VSS=−13 [V], but embodiments of the invention are not limited thereto.

In the input circuit part INC illustrated in FIG. 9, a first-first transistor T1A and a first-second transistor T1B are turned on when the voltage of the clock node 13 to which the clock signal CLK1 is input is the gate high voltage VGH, and transmits the voltage of the first input signal input to the first input node 11, to the first control node Q. The first-first transistor T1A and the first-second transistor T1B are connected in series between the first input node 11 and the first control node Q to configure a two transistor series (TTS) circuit. In the TTS circuit, the transistors are connected in series and a drain-source voltage Vds of each transistor is reduced. Because a leakage current is in proportion to the drain-source voltage Vds of the transistor, the TTS circuit has less leakage current. In addition, when one of the two transistors is in an off state, the leakage current can be blocked.

A first-third transistor T1C is turned on when the voltage of the first control node Q is charged to a voltage equal to or higher than the gate high voltage VGH, and increases a voltage of a first buffer node 12 to the gate high voltage VGH. The first-third transistor T1C may control a gate-source voltage Vgs of the first-second transistor T1B to a negative voltage or a backward bias voltage when the first-first transistor T1A and the first-second transistor T1B are in the off state, thereby further increasing the leakage current blocking function of the TTS circuit.

The first-first transistor T1A includes a gate electrode connected to the clock node 13, a first electrode connected to the first input node 11, and a second electrode connected to the first buffer node 12. The first-second transistor T1B includes a gate electrode connected to the clock node CLK, a first electrode connected to the first buffer node 12, and a second electrode connected to the first control node Q. The first-third transistor T1C includes a gate electrode connected to the first control node Q, a first electrode connected to a first power node to which the gate high voltage VGH is applied, and a second electrode connected to the first buffer node 12.

A second-first transistor T2A and a second-second transistor T2B are connected in series between the second input node 14 and the second control node QB, transmit the second input signal to the second control node QB, and generate little leakage current. A second-third transistor T2C is turned on when the voltage of the second control node QB is charged to a voltage equal to or higher than the gate high voltage VGH, and increases a voltage of a second buffer node 15 to the gate high voltage VGH. A leakage current blocking effect of the second-first, second-second, and second-third transistors T2A, T2B, and T2C is substantially the same as that of the TTS circuit (T1A, T1B, T1C) of the first input node 11 described above, and thus, description thereof will not be repeated.

The second-first transistor T2A includes a gate electrode connected to the clock node 13, a first electrode connected to the second input node 14, and a second electrode connected to the second buffer node 15. The second-second transistor T2B includes a gate electrode connected to the clock node CLK, a first electrode connected to the second buffer node 15, and a second electrode connected to the second control node QB. The second-third transistor T2C includes a gate electrode connected to the second control node QB, a first electrode connected to the first power node to which the gate high voltage VGH is applied, and a second electrode connected to the second buffer node 15.

The signal transmitter illustrated in FIG. 9 can output the output signals Vout(n) and Voutb(n) and the carry signals Cout(n) and Coutb(n) having inverted phases without an inverter circuit that is connected between the first control node Q and the second control node QB and an inverter circuit that is connected to the output node.

The output circuit part OUTC includes a first output buffer, a second output buffer, a third output buffer, and a fourth output buffer that share the first and second control nodes Q and QB.

The first output buffer includes third and fourth transistors T3 and T4 that output the pulse of the first output signal Vout(n) via a first output node 16 in response to the voltages of the first and second control nodes Q and QB. The third transistor T3 is a pull-up transistor that pulls up the pulse of the first output signal Vout(n). A first capacitor CQ for bootstrapping may be connected between the first control node Q and the first output node 16. The fourth transistor T4 is a pull-down transistor that pulls down the pulse of the first output signal Vout(n). The third transistor T3 includes a gate electrode connected to the first control node Q, a first electrode connected to the first power node to which the gate high voltage VGH is applied, and a second electrode connected to the first output node 16. The fourth transistor T4 includes a gate electrode connected to the second control node QB, a first electrode connected to the first output node 16, and a second electrode connected to a second power node to which the gate low voltage VGL is applied.

The second output buffer includes fifth and sixth transistors T5 and T6 that output the pulse of the first carry signal Cout(n) via a second output node 17 in response to the voltages of the first and second control nodes Q and QB. The pulse of the first carry signal Cout(n) is output with the same phase as the pulse of the first output signal Vout(n) as illustrated in FIGS. 11A to 11C. The fifth transistor T5 is a pull-up transistor, and the sixth transistor T6 is a pull-down transistor. The fifth transistor T5 includes a gate electrode connected to the first control node Q, a first electrode connected to the first power node to which the gate high voltage VGH is applied, and a second electrode connected to the second output node 17. The sixth transistor T6 includes a gate electrode connected to the second control node QB, a first electrode connected to the second output node 17, and a second electrode connected to a third power node to which the first low-potential reference voltage VSS is applied.

The third output buffer includes seventh and eighth transistors T7 and T8 that output the pulse of the second carry signal Coutb(n) via a third output node 18 in response to the voltages of the first and second control nodes Q and QB. The third output buffer may operate in a complementary manner to the second output buffer and may output the pulse of the second carry signal Coutb(n). The pulse of the second carry signal Coutb(n) is output with the same phase as the pulse of the second output signal Voutb(n) as illustrated in FIGS. 11A to 11C. The pulse of the second carry signal Coutb(n) has an inverted phase with respect to the pulse of the first carry signal Cout(n). At the same time as the pulse of the first carry signal Cout(n) rises, the pulse of the second carry signal Coutb(n) falls. And, at the same time as the pulse of the first carry signal Cout(n) falls, the pulse of the second carry signal Coutb(n) rises.

The seventh transistor T7 includes a gate electrode connected to the first control node Q, a first electrode connected to the third power node to which the first low-potential reference voltage VSS is applied, and a second electrode connected to the third output node 18. The eighth transistor T8 includes a gate electrode connected to the second control node QB, a first electrode connected to the third output node 18, and a second electrode connected to the first power node to which the gate high voltage VGH is applied.

The fourth output buffer includes ninth and tenth transistors T9 and T10 that output the pulse of the second output signal Voutb(n) via a fourth output node 19 in response to the voltages of the first and second control nodes Q and QB. The fourth output buffer may operate in a complementary manner to the first output buffer and may output the pulse of the second output signal Voutb(n). The pulse of the second output signal Voutb(n) has an inverted phase with respect to the pulse of the first output signal Vout(n) as illustrated in FIGS. 11A to 11C. At the same time as the pulse of the first output signal Vout(n) rises, the pulse of the second output signal Voutb(n) falls. At the same time as the pulse of the first output signal Vout(n) falls, the pulse of the second output signal Voutb(n) rises. The ninth transistor T9 is a pull-down transistor, and the tenth transistor T10 is a pull-up transistor. A second capacitor CQB for bootstrapping may be connected between the second control node QB and the fourth output node 19. The ninth transistor T9 includes a gate electrode connected to the first control node Q, a first electrode connected to the second power node to which the gate low voltage VGL is applied, and a second electrode connected to the fourth output node 19. The tenth transistor T10 includes a gate electrode connected to the second control node QB, a first electrode connected to the fourth output node 19, and a second electrode connected to the first power node to which the gate high voltage VGH is applied.

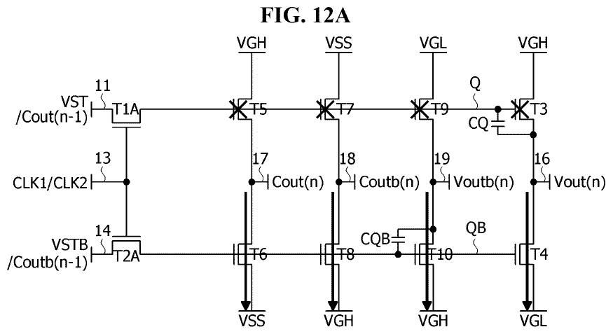

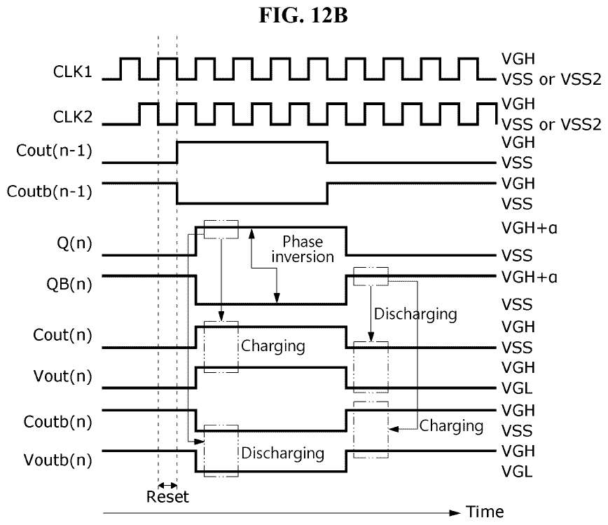

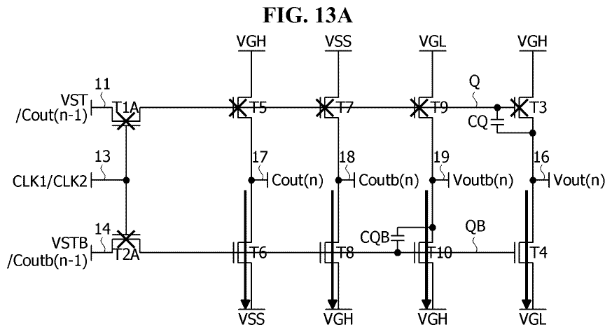

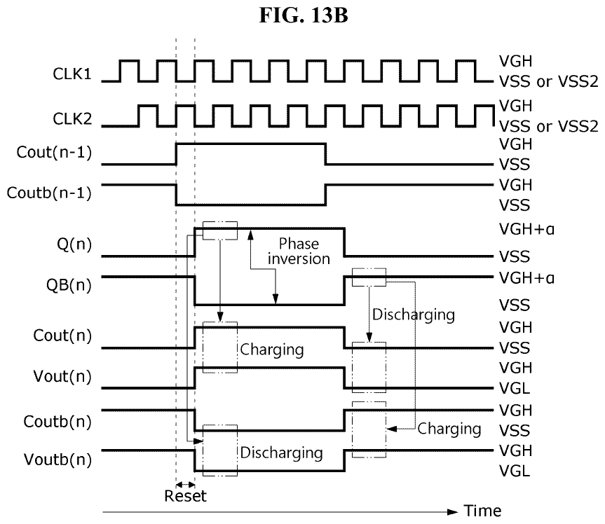

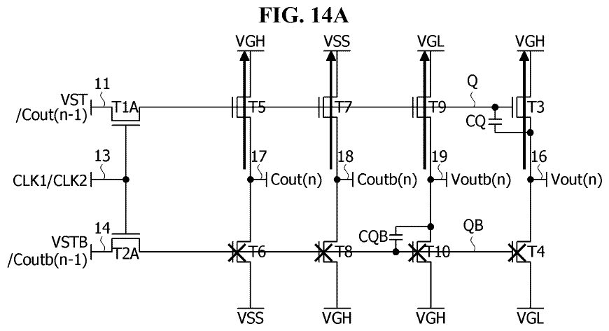

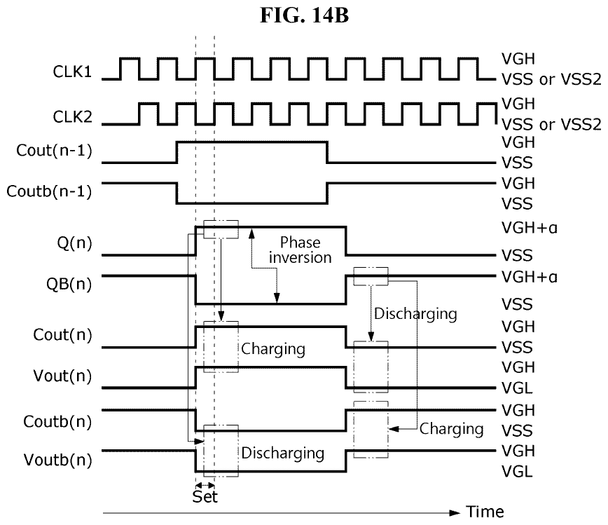

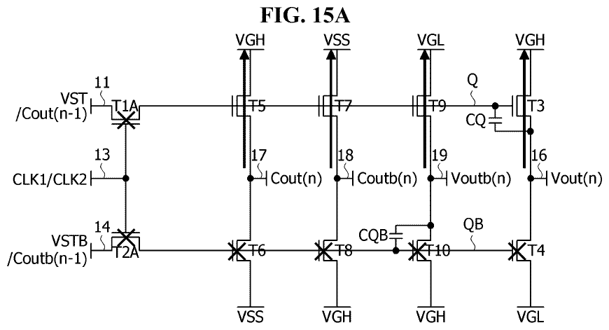

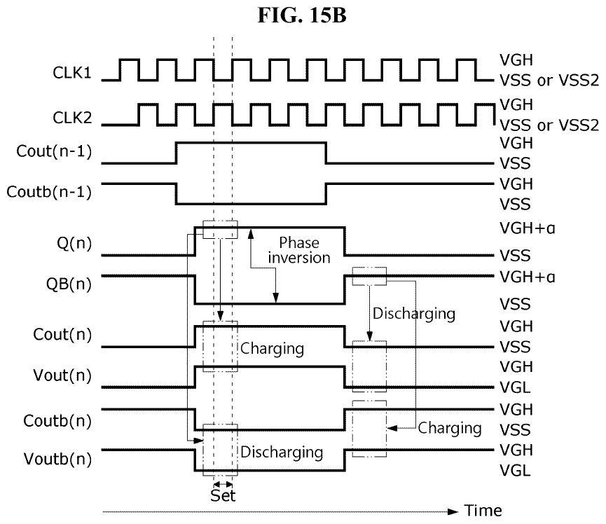

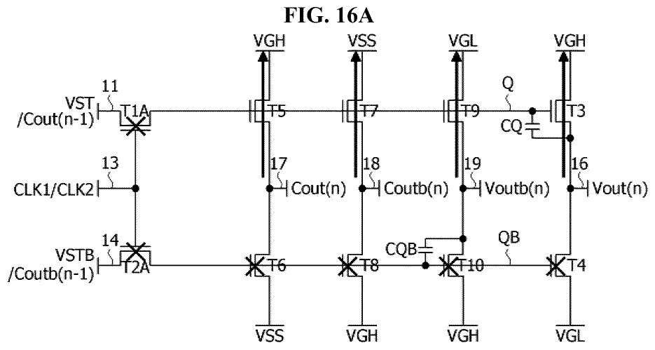

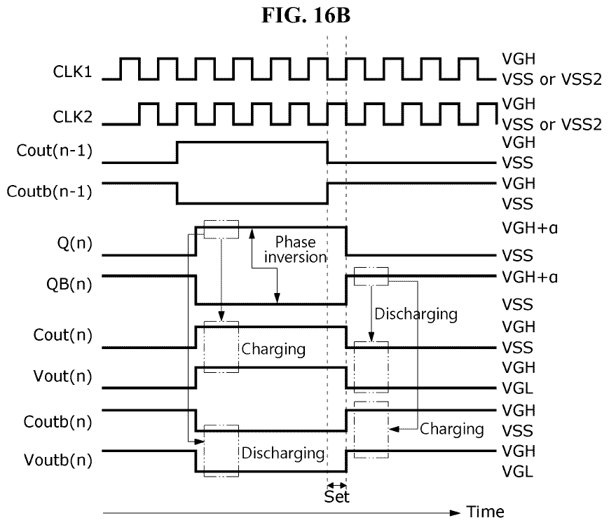

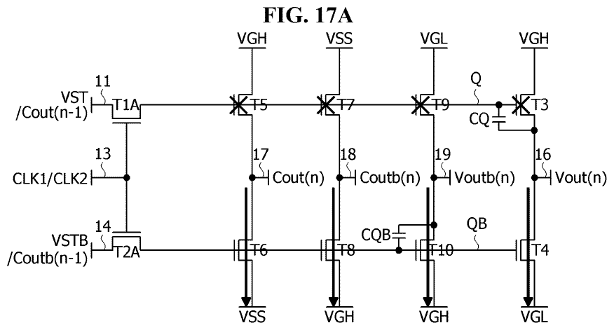

The pulses of the carry signals Cout(n) and Coutb(n) rise from the first low-potential reference voltage VSS, which is lower than the gate low voltage VGL, to the gate high voltage VGH as illustrated in FIG. 12B. In contrast, the pulses of the output signals Vout(n) and Voutb(n) rise from the gate low voltage VGL to the gate high voltage VGH. Accordingly, the pulse voltages of the carry signals Cout(n) and Coutb(n) are greater than those of the output signals Vout(n) and Voutb(n). When the pulse voltages of the carry signals Cout(n) and Coutb(n) are appropriately increased, there is less influence of an RC delay in the carry signal line.

The signal transmitter illustrated in FIG. 10 has a structure of the input circuit part partially different from the embodiment illustrated in FIG. 9 described above. In relation to the pixel circuit illustrated in FIG. 10, redundant description of the pixel circuit illustrated in FIG. 9 will not be repeated. In the signal transmitter illustrated in FIG. 10, to reduce a leakage current, low voltages of the clock signals CLK1 and CLK2 may be set to a second low-potential reference voltage VSS2 lower than the first low-potential reference voltage VSS. The second low-potential reference voltage VSS2 may be −16 V, but is not limited thereto. The second low-potential reference voltage VSS2 may control a gate-source voltage Vgs of each of transistors T1A and T2A to a negative voltage or a backward bias voltage when the transistors T1A and T2A that configure an input circuit part INC are in the off state, thereby reducing a leakage current.

Referring to FIG. 10, the input circuit part INC includes the first and second transistors T1A and T2A.

The first transistor T1A is turned on when the voltage of the clock node 13 is the gate high voltage VGH, and transmits the voltage of the first input signal VST/Cout(n−1) to the first control node Q. The second transistor T2A is turned on when the voltage of the clock node 13 is the gate high voltage VGH, and transmits the voltage of the second input signal VSTB/Coutb(n−1) to the second control node QB. The first transistor T1A includes a gate electrode connected to the clock node 13, a first electrode connected to the first input node 11, and a second electrode connected to the first control node Q. The second transistor T2A includes a gate electrode connected to the clock node 13, a first electrode connected to the second input node 14, and a second electrode connected to the second control node QB.

FIGS. 12A to 17B are diagrams illustrating an operation of the signal transmitter illustrated in each of FIGS. 9 and 10 in steps. The operation of the signal transmitter will be described focusing on the pixel circuit illustrated in FIG. 10. The pixel circuit illustrated in FIG. 9 is different from the pixel circuit illustrated in FIG. 10 in that the low voltage of the clock signal is lower, but operates substantially in the same manner as the pixel circuit illustrated in FIG. 10. The signal transmitter illustrated in each of FIGS. 12A to 17A is an n-th (where n is a natural number) signal transmitter. In the description of the embodiment, first and second input signals that are input to the n-th signal transmitter are described as carry signals Cout(n−1) and Coutb(n−1) that are output from an (n−1)th signal transmitter.

In FIGS. 12A to 17A, when the control nodes Q and QB are charged, not only the voltage of the first control node Q but also the voltage of the second control node QB may be boosted to VGH +α higher than the gate high voltage VGH in an interval where bootstrapping occurs through capacitor coupling. With the effect of bootstrapping, it is possible to secure a wider operational margin when the threshold voltage Vth is positively shifted due to Positive gate bias stress of the transistors T3 to T10 that drive the output circuit part OUTC, thereby extending the lifetime of the gate driving circuit and the display panel.

Referring to FIGS. 12A and 12B, the signal transmitter is in a reset step Reset. In the reset step Reset, the voltage of the first clock signal CLK1 is the gate high voltage VGH. In this case, while the voltage of the first input signal Cout(n−1) is the low-potential reference voltage VSS, and the voltage of the second input signal Coutb(n−1) is the gate high voltage VGH. As a result, the first and second transistors T1A and T2A are turned on in response to the gate high voltage VGH of the first clock signal CLK1.

In FIGS. 12A and 12B, the voltage of the first control node Q is discharged to the same voltage as the low-potential reference voltage VSS of the first input signal Cout(n−1), and the voltage of the second control node QB is charged to a voltage VGH +α equal to or higher than the gate high voltage by bootstrapping. Accordingly, in the reset step Reset illustrated in FIGS. 12A and 12B, while the transistors T3, T5, T7, and T9 with the gate electrode connected to the first control node Q are turned off, the transistors T4, T6, T8, and T10 with the gate electrode connected to the second control node QB are turned on. As a result, in the reset step Reset illustrated in FIGS. 12A and 12B, the voltage of the first output signal Vout(n) is the gate low voltage VGL, and the voltage of the first carry signal Cout(n) is the low-potential reference voltage VSS. Meanwhile, the voltages of the second output signal Voutb(n) and the second carry signal Coutb(n) are the gate high voltage VGH.

Referring to FIGS. 13A and 13B, the signal transmitter is maintained in the reset step Reset. In the reset step Reset, the voltage of the first clock signal CLK1 is the gate low voltage VGL. In this case, while the voltage of the first input signal Cout(n−1) is the gate high voltage VGH, the voltage of the second input signal Coutb(n−1) is the low-potential reference voltage VSS. As a result, because the first and second transistors T1A and T2A are turned off in response to the gate low voltage VGL of the first clock signal CLK1, the first and second control nodes Q and QB are brought into a floating state and maintained in the previous state.

Referring to FIGS. 14A and 14B, the operation of the signal transmitter changes to a set step Set. In the set step Set, the voltage of the first clock signal CLK1 is the gate high voltage VGH. In this case, while the voltage of the first input signal Cout(n−1) is the gate high voltage VGH, the voltage of the second input signal Coutb(n−1) is the low-potential reference voltage VSS. As a result, the first and second transistors T1A and T2A are turned on in response to the gate high voltage VGH of the first clock signal CLK1.

In FIGS. 14A and 14B, while the voltage of the first control node Q is charged to a voltage VGH+α equal to or higher than the gate high voltage by bootstrapping, the voltage of the second control node QB is discharged to the low-potential reference voltage VSS of the second input signal Coutb(n−1). Accordingly in the set step Set illustrated in FIGS. 14A and 14B, while the transistors T3, T5, T7, and T9 with the gate electrode connected to the first control node Q are turned on, the transistors T4, T6, T8, and T10 with the gate electrode connected to the second control node QB are turned off. As a result, in the set step illustrated in FIGS. 14A and 14B, the voltages of the first output signal Vout(n) and the first carry signal Cout(n) are charged and rise to the gate high voltage VGH. Meanwhile, the voltage of the second output signal Voutb(n) is discharged and is decreased to the gate low voltage VGL, and the voltage of the second carry signal Coutb(n) is decreased to the low-potential reference voltage VSS.

Referring to FIGS. 15A to 16B, the signal transmitter is maintained in the set step Set. In the set step Set, the voltage of the first clock signal CLK1 is the gate low voltage VGL. As a result, because the first and second transistors T1A and T2A are turned off in response to the gate low voltage VGL of the first clock signal CLK1, the first and second control nodes Q and QB are brought into a floating state and maintained in the previous state.

Referring to FIGS. 17A and 17B, the operation of the signal transmitter changes to a reset step. In the reset step, the voltage of the first clock signal CLK1 is the gate high voltage VGH. In this case, while the voltage of the first input signal Cout(n−1) is the gate low voltage VGL, the voltage of the second input signal Coutb(n−1) is the gate high voltage VGH. As a result, the first and second transistors T1A and T2A are turned on in response to the gate high voltage VGH of the first clock signal CLK1.

In FIGS. 17A and 17B, while the voltage of the second control node QB is charged to a voltage VGH +α equal to or higher than the gate high voltage by bootstrapping, the voltage of the first control node Q is discharged to the low-potential reference voltage VSS of the first input signal Cout(n−1). Accordingly, in the reset step Reset illustrated in FIGS. 17A and 17B, while the transistors T3, T5, T7, and T9 with the gate electrode connected to the first control node Q are turned off, the transistors T4, T6, T8, and T10 with the gate electrode connected to the second control node QB are turned on. As a result, in the reset step Reset illustrated in FIGS. 17A and 17B, the voltages of the second output signal Voutb(n) and the second carry signal Coutb(n) rise to the gate high voltage VGH. Meanwhile, the voltage of the first output signal Vout(n) is decreased to the gate low voltage VGL, and the voltage of the first carry signal Cout(n) is decreased to the low-potential reference voltage VSS.

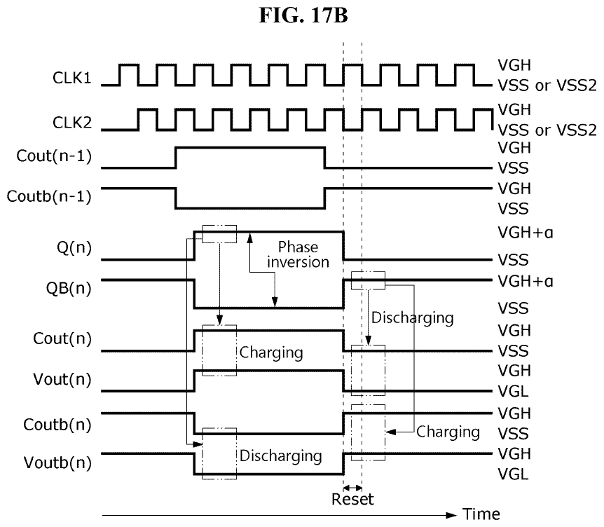

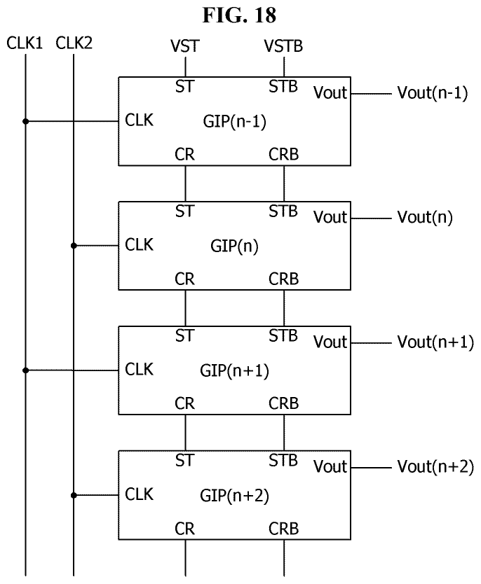

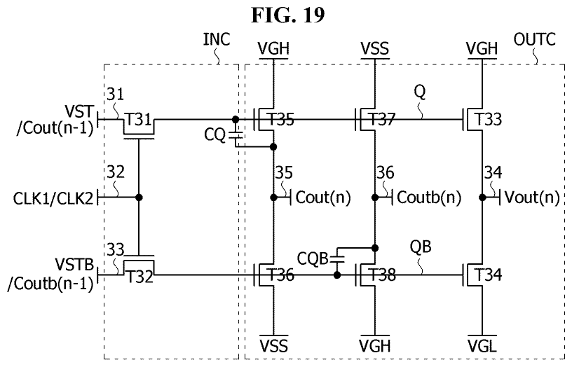

FIGS. 18 and 19 are diagrams illustrating a configuration of a gate driver according to another embodiment of the invention. FIG. 18 is a diagram schematically illustrating a cascade connection structure of a shift register in the gate driver. FIG. 19 is a circuit diagram illustrating an embodiment of a circuit configuration of a signal transmitter illustrated in FIG. 18. In this embodiment, redundant description of the above-described description will not be repeated. In this embodiment, signals that are input to the signal transmitter are substantially the same as those in the above-described embodiments, and this embodiment is different from the above-described embodiments in that a single output signal is output.

Referring to FIGS. 18 and 19, each of signal transmitters GIP(n−1) to GIP(n+2) may be implemented as a shift register including a first input node ST, a second input node STB, a clock node CLK, a first carry signal node CR, a second carry signal node CRB, and a first output node Vout. The shift register may adjust the pulse widths of output signals Vout(n-1) to Vout(n+2) according to the pulse widths of the start signals VST and VSTB as illustrated in FIGS. 11A to 11C. The pulse widths of the output signals Vout(n−1) to Vout(n+2) are substantially the same as the pulse widths of the start signals VST and VSTB.

Each of the signal transmitters GIP(n−1) to GIP(n+2) includes an input circuit part INC and an output circuit part OUTC as illustrated in FIG. 19.

The input circuit part INC may include first and second transistors T31 and T32, but embodiments of the invention are not limited thereto. For example, the input circuit part INC may be implemented in the same manner as the input circuit part illustrated in FIG. 9. The first transistor T31 includes a gate electrode connected to a clock node 32, a first electrode connected to a first input node 31, and a second electrode connected to a first control node Q. The second transistor T32 includes a gate electrode connected to the clock node 32, a first electrode connected to a second input node 33, and a second electrode connected to a second control node QB.

The output circuit part OUTC includes a first output buffer, a second output buffer, and a third output buffer that share the first and second control nodes Q and QB.

The first output buffer includes third and fourth transistors T33 and T34 that output the pulse of the output signal Vout(n) via a first output node 34 in response to voltages of the first and second control nodes Q and QB. The second output buffer includes fifth and sixth transistors T35 and T36 that output the pulse of a first carry signal Cout(n) via a second output node 35 in response to the voltages of the first and second control nodes Q and QB. The third output buffer includes seventh and eighth transistors T37 and T38 that output the pulse of a second carry signal Coutb(n) via a third output node 36 in response to the voltages of the first and second control nodes Q and QB.

The output circuit part OUTC may include bootstrapping capacitors CQ and CQB. A first capacitor CQ may be connected between the first control node Q and the second output node 35. A second capacitor CQB may be connected between the second control node QB and the third output node 36.

According to one or more embodiments of the invention, the display device may be applied to mobile devices, video phones, smart watches, watch phones, wearable device, foldable device, rollable device, bendable device, flexible device, curved device, sliding device, variable device, electronic organizer, electronic books, portable multimedia players (PMPs), personal digital assistants (PDAs), MP3 players, mobile medical devices, desktop PCs, laptop PCs, netbook computers, workstations, navigations, vehicle navigations, vehicle display devices, vehicle devices, theater devices, theater display devices, televisions, wallpaper devices, signage devices, game devices, laptops, monitors, cameras, camcorders, and home appliances, etc. Additionally, the display apparatus according to one or more embodiments of the invention may be applied to organic light emitting lighting devices or inorganic light emitting lighting devices.

According to embodiments of the invention, it is possible to output gate signals capable of pulse width modulation using a single shift register.

According to embodiments of the invention, it is possible to output gate signals having inverted phases using a single shift register without an inverter circuit. According to the embodiments, it is possible to reduce a leakage path by removing an inverter from the configuration of the gate driving circuit, and to reduce or block a leakage current by applying specific structure changes and conditions to the gate driving circuit. As a result, according to the embodiments, it is possible to improve the reliability and the power consumption of the gate driving circuit.

According to embodiments of the invention, because it is possible to output gate signals having inverted phases using a single shift register, it is possible to reduce the size of the gate driving circuit for driving the pixels and to implement a narrow bezel of the display panel.

According to embodiments of the invention, because the display panel can be manufactured using oxide TFTs for all transistors provided in the display panel, it is possible to reduce manufacturing costs and power consumption.

Although certain embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. A gate driving circuit comprising a plurality of signal transmitters to which a clock signal is applied, wherein each of the plurality of signal transmitters includes:
a clock node to which the clock signal is input;
a first input node to which a first input signal is input;
a second input node to which a second input signal is input;
a first carry signal node to which a first carry signal is input;
a second carry signal node to which a second carry signal is input; and
a first output node from which a first output signal is output.

2. The gate driving circuit according to claim 1, wherein:
the first input signal and the second input signal are opposite in phase to each other;
the first input signal is a first start signal or a first carry signal that is output from a previous signal transmitter; and
the second input signal is a second start signal having an inverted phase with respect to the first start signal or a second carry signal that is output from the previous signal transmitter.

3. The gate driving circuit according to claim 2, wherein a pulse width of the first output signal is varied in proportion to a pulse width of the input signal.

4. The gate driving circuit according to claim 1, wherein each of the plurality of signal transmitters further includes a second output node from which a second output signal having an inverted phase with respect to the first output signal is output.

5. The gate driving circuit according to claim 1, wherein each of the plurality of signal transmitters further includes:
a first control node;
a second control node; and
an input circuit part and an output circuit part connected to the first control node and the second control node.

6. The gate driving circuit according to claim 5, wherein the input circuit part includes:
a first-first transistor including a gate electrode connected to the clock node, a first electrode connected to the first input node, and a second electrode connected to a first buffer node;
a first-second transistor including a gate electrode connected to the clock node, a first electrode connected to the first buffer node, and a second electrode connected to the first control node;
a first-third transistor including a gate electrode connected to the first control node, a first electrode connected to a first power node to which a first gate voltage is applied, and a second electrode connected to the first buffer node;
a second-first transistor including a gate electrode connected to the clock node, a first electrode connected to the second input node, and a second electrode connected to a second buffer node;
a second-second transistor including a gate electrode connected to the clock node, a first electrode connected to the second buffer node, and a second electrode connected to the second control node; and
a second-third transistor including a gate electrode connected to the second control node, a first electrode connected to the first power node, and a second electrode connected to the second buffer node.

7. The gate driving circuit according to claim 5, wherein the input circuit part includes:
a first transistor including a gate electrode connected to the clock node, a first electrode connected to the first input node, and a second electrode connected to the first control node; and
a second transistor including a gate electrode connected to the clock node, a first electrode connected to the second input node, and a second electrode connected to the second control node.

8. The gate driving circuit according to claim 5, wherein:
each of the plurality of signal transmitters further includes a second output node from which a second output signal having an inverted phase with respect to the first output signal is output;
the output circuit part includes a first output buffer, a second output buffer, a third output buffer, and a fourth output buffer that share the first control node and the second control node;
the first output buffer is configured to output a pulse of the first output signal via a first output node in response to charged voltages of the first control node and the second control node;
the second output buffer is configured to output a pulse of the first carry signal via a second output node in response to the charged voltages of the first control node and the second control node;
the third output buffer is configured to output a pulse of the second carry signal via a third output node in response to the charged voltages of the first control node and the second control node; and
the fourth output buffer is configured to output a pulse of the second output signal via a fourth output node in response to the charged voltages of the first control node and the second control node.

9. The gate driving circuit according to claim 8, wherein:
the first output buffer includes:
a third transistor including a gate electrode connected to the first control node, a first electrode connected to a first power node to which a first gate voltage is applied, and a second electrode connected to the first output node; and
a fourth transistor including a gate electrode connected to the second control node, a first electrode connected to the first output node, and a second electrode connected to a second power node to which a second gate voltage lower than the first gate voltage is applied;
the second output buffer includes:
a fifth transistor including a gate electrode connected to the first control node, a first electrode connected to the first power node, and a second electrode connected to the second output node; and
a sixth transistor including a gate electrode connected to the second control node, a first electrode connected to the second output node, and a second electrode connected to a third power node to which a reference voltage lower than the second gate voltage is applied;
the third output buffer includes:
a seventh transistor including a gate electrode connected to the first control node, a first electrode connected to the third power node, and a second electrode connected to the third output node; and
an eighth transistor including a gate electrode connected to the second control node, a first electrode connected to the third output node, and a second electrode connected to the first power node; and
the fourth output buffer includes:
a ninth transistor including a gate electrode connected to the first control node, a first electrode connected to the second power node, and a second electrode connected to the fourth output node; and
a tenth transistor including a gate electrode connected to the second control node, a first electrode connected to the fourth output node, and a second electrode connected to the first power node.

10. The gate driving circuit according to claim 9, wherein the output circuit part includes:
a first capacitor connected between the first control node and the first output node; and
a second capacitor connected between the first control node and the fourth output node.

11. The gate driving circuit according to claim 5, wherein:
the output circuit part includes a first output buffer, a second output buffer, and a third output buffer that share the first control node and the second control node;
the first output buffer is configured to output a pulse of the first output signal via a first output node in response to charged voltages of the first control node and the second control node;
the second output buffer is configured to output a pulse of the first carry signal via a second output node in response to the charged voltages of the first control node and the second control node; and
the third output buffer is configured to output a pulse of the second carry signal via a third output node in response to the charged voltages of the first control node and the second control node.

12. The gate driving circuit according to claim 11, wherein:
the first output buffer includes:
a third transistor including a gate electrode connected to the first control node, a first electrode connected to a first power node to which a first gate voltage is applied, and a second electrode connected to the first output node; and
a fourth transistor including a gate electrode connected to the second control node, a first electrode connected to the first output node, and a second electrode connected to a second power node to which a second gate voltage lower than the first gate voltage is applied;
the second output buffer includes:
a fifth transistor including a gate electrode connected to the first control node, a first electrode connected to the first power node, and a second electrode connected to the second output node; and
a sixth transistor including a gate electrode connected to the second control node, a first electrode connected to the second output node, and a second electrode connected to a third power node to which a reference voltage lower than the second gate voltage is applied; and
the third output buffer includes:
a seventh transistor including a gate electrode connected to the first control node, a first electrode connected to the third power node, and a second electrode connected to the third output node; and
an eighth transistor including a gate electrode connected to the second control node, a first electrode connected to the third output node, and a second electrode connected to the first power node.

13. The gate driving circuit according to claim 12, wherein the output circuit part includes:
a first capacitor connected between the first control node and the second output node; and
a second capacitor connected between the second control node and the third output node.

14. A display device comprising a display panel in which a plurality of data lines, a plurality of gate lines, a plurality of pixels connected to the corresponding data lines and gate lines, and a gate driving circuit configured to output gate signals to the gate lines are provided,
wherein:
each of the plurality of pixels is configured to receive at least a first gate signal as input;
the gate driving circuit includes a plurality of signal transmitters to which a clock signal is applied;
each of the plurality of signal transmitters includes:
a clock node to which the clock signal is input;
a first input node to which a first input signal is input;
a second input node to which a second input signal having an inverted phase with respect to the first input signal is applied;
a first carry signal node to which a first carry signal is input;
a second carry signal node to which a second carry signal having an inverted phase with respect to the first carry signal is input; and
a first output node from which the first gate signal is output.

15. The display device according to claim 14, wherein:
the first input signal is a first start signal or a first carry signal that is output from a previous signal transmitter; and
the second input signal is a second start signal having an inverted phase with respect to the first start signal or a second carry signal that is output from the previous signal transmitter.

16. The display device according to claim 15, wherein a pulse width of the first gate signal is varied in proportion to a pulse width of the input signal.

17. The display device according to claim 14, wherein:
each of the plurality of pixels is configured to receive a second gate signal having an inverted phase with respect to the first gate signal as input; and
each of the plurality of signal transmitters further includes a second output node from which the second gate signal is output.

18. The display device according to claim 14, wherein each of the plurality of signal transmitters further includes:
a first control node;
a second control node; and
an input circuit part and an output circuit part connected to the first control node and the second control node.

19. The display device according to claim 18, wherein the input circuit part includes:
a first-first transistor including a gate electrode connected to the clock node, a first electrode connected to the first input node, and a second electrode connected to a first buffer node;
a first-second transistor including a gate electrode connected to the clock node, a first electrode connected to the first buffer node, and a second electrode connected to the first control node;
a first-third transistor including a gate electrode connected to the first control node, a first electrode connected to a first power node to which a first gate voltage is applied, and a second electrode connected to the first buffer node;
a second-first transistor including a gate electrode connected to the clock node, a first electrode connected to the second input node, and a second electrode connected to a second buffer node;
a second-second transistor including a gate electrode connected to the clock node, a first electrode connected to the second buffer node, and a second electrode connected to the second control node; and
a second-third transistor including a gate electrode connected to the second control node, a first electrode connected to the first power node, and a second electrode connected to the second buffer node.

20. The display device according to claim 18, wherein the input circuit part includes:
a first transistor including a gate electrode connected to the clock node, a first electrode connected to the first input node, and a second electrode connected to the first control node; and
a second transistor including a gate electrode connected to the clock node, a first electrode connected to the second input node, and a second electrode connected to the second control node.
